(19) United States
(12) Patent Application Publication
(10) Pub. No.: US 2009/0089024 A1
(43) Pub. Date: Apr. 2, 2009

(54) METHODS AND ARRANGEMENT FOR CREATING MODELS FOR FINE-TUNING RECIPES

(76) Inventors: Chung-Ho Huang, San Jose, CA (US); Chang L. Koh, Fremont, CA (US)

Correspondence Address: IPSG, P.C., P.O. BOX 700640, SAN JOSE, CA, 95170, US

(21) Appl. No.: 12/235,453

(22) Filed: Sep. 22, 2008

Related U.S. Application Data
(60) Provisional application No. 60/976,165, filed on Sep. 28, 2007.

(51) Int. Cl. G06F 17/10

(52) U.S. Cl. 703/2

(57) ABSTRACT

An arrangement for creating a model for gathering measurement data about a processed substrate by a user of a plasma processing system is provided. The arrangement includes a generic model builder, which is configured for at least creating the model. The model is a relationship between a set of input data and a set of output data. The arrangement also includes an input module, which includes the set of input data from a plurality of input sources. The arrangement includes an input conditioning and validation module, which is configured for at least determining the integrity of the set or input data. The arrangement further includes a relationship module, which is configured for at least creating a set of mathematical relationships. The arrangement yet also includes an output conditioning and validation module, which is configured for at least determining the integrity of the set of output data.

### PRIORITY CLAIM

This application is related to and claims priority under 35 U.S.C. §119(e) to a commonly assigned provisional patent application entitled “Methods And Arrangement For Creating Models For Fine-Tuning Recipes,” by Huang et al., Attorney Docket Number P1753P/LMRX-P146P1, Application Ser. No. 60/976,165, filed on Sep. 28, 2007, which is incorporated by reference herein.

### BACKGROUND OF THE INVENTION

Advances in plasma processing have facilitated growth in the semiconductor industry. Generally, a plurality of semiconductor devices may be created from a single processed wafer. Recipes have long been employed to provide the steps for creating the semiconductor devices. However, due to external conditions, such as different chamber conditions, recipes may have to be adjusted in order to account for the variations.

A method commonly employed to adjust recipes is a generic recipe tuning method. With a generic recipe tuning method, one or more wafers may be measured by a stand-alone metrology tool after the wafer has been processed. However, with the generic recipe tuning method, the measurement data is usually not able to be applied immediately to adjust the recipe for the current batch of wafers. Instead, the measurements may be fed forward and be utilized for fine-tuning the recipe for the next batch or wafers. Thus, if a problem with the recipe is identified for the current chamber, the knowledge gained from the measurements may not be applied until the current batch of wafers has been processed.

In recent years, an integrated metrology method has been implemented enabling measurements to be taken in-line, thereby enabling the measurements taken to be sent as feedback to the process control computer of the plasma processing system. Thus, the recipe may be fine-tuned such that the next wafer within the same batch of wafers may be able to benefit from the adjusted recipe. In other words, unlike the generic recipe tuning method, the integrated metrology method may be employed to make adjustment to the recipe for the immediate batch of wafers instead of having to wait until the current batch of wafers have been processed.

With both the generic recipe tuning method and especially with the integrated metrology method, a plurality of measurements (e.g., sidewall angle measurement, critical dimension between the edge and the center, measurements for determining uniformity, and the like) may be taken. In order to gather the measurement data, one or more models may be employed to gather the necessary measurements to determine the adjustments that may have to be made to a recipe.

As discussed herein, a model refers to a relationship between one or more inputs with one or more outputs. The relationship is a mathematical relationship that is usually expressed as an equation. Generally, the equation is recipe specific. Input data may come from a variety of sources, including but are not limited to, sensor data, process data, and software data. The output is usually employed to adjust a single parameter of a recipe.

Over time, new models may be created or existing models may be modified. In an example, new models may have to be created if a change to a recipe introduces new parameters. In another example, a model for generating measurement data for a parameter may have to be modified if acceptable ranges for that parameter have changed. In yet another example, new models may have to be created when a new recipe has been introduced.

Despite the reasons for the need of a new or a modified model, the process of creating a new model and/or modifying a current model is usually not a simple task. The process usually involves at least two parties, a tool user and a software engineer. The tool user is usually an employee of a company that owns the plasma processing system. The tool user may have identified a need for creating a new model and/or adjusting a current model. The tool user, therefore, is usually responsible for providing the specifications to the software engineer. The software engineer is usually not an employee of the company and is usually associated with the manufacturer of the plasma processing system.

To facilitate discussion, FIG. 1 shows a simple flowchart of a prior art method for obtaining a new model. Consider the situation wherein, for example, a tool user of a plasma processing system own bad Company A has identified a need for a new model.

At a first step 102, the tool user may identify the parameters for the model. In other words, the tool user may have to identify the input, the equation, and the desired output.

At a next step 104, the tool user may provide the required parameters to an outside party. Since the tool user has to go through an outside party (i.e., software engineer) in order to create and/or modify a model, the tool user may have to share proprietary information with the outside party. In an example, a recipe for etching a wafer may include steps that give Company A a competitive edge over Company B. However, since the tool user from Company A wants to create a new model, the tool user may have to supply proprietary data about the recipe to the outside party in order for the outside party to modify the model.

The current method of modifying a current model and/or generating a new model creates a potential intellectual property risk for both the tool user and the manufacturer of the plasma processing system. Those skilled in the art are aware that a recipe may include proprietary data that may provide a company a unique edge against its competitors. Therefore, by sharing details about the recipe with an outside party, the tool user is exposing at least part of the proprietary data to an outside party.

In addition, there may be a risk that part of the intellectual property (e.g., proprietary recipe) may be made publicly available to non-intended users. In an example, an engineer associated with a manufacturer of the plasma processing system may be concurrently developing models for two competing companies. During his interaction with the clients, the engineer may inadvertently send a model intended for Company A to his contact at Company B. Due to the careless action of the engineer, proprietary information of Company A has been inadvertently shared and the engineer and the manufacturer of the plasma processing tool may be liable.

In addition to potential intellectual property exposure, the task of creating and/or modifying a model may take weeks, if not months, before the task may be completed. The long turnaround time may be a result of several reasons. First, since the tool user has to work with an outside party (i.e., software engineer) in order to accomplish the task of creating and/or modifying a model, the turnaround time for completing the task may be dependent upon the work schedule of the outside party. In an example, due to the software engineer's busy schedule, the software engineer may not be able to handle the tool user's request until two months later. Second, the long turnaround time may also be partly due to the outside party having to familiarize himself with the recipe. Third, the process may require at least one test cycle for both the software engineer and the tool user to test the changes to the code before the new code with the embedded model is moved into production and be made available for fine-tuning a recipe.

At a next step 106, the tool user may receive the model and perform a test run with the model. In other words, once the engineer has created the model, the model may be sent to the tool user to be tested.

At a next step 108, a determination is made by the tool user on whether or not the model is performing according to his specification. If not, then steps 104 and 106 may be repeated.

However, if no additional change is required, then at a next step 110, the tool user may receive a new production copy of a system software program for his current plasma processing system with the new model embedded into the system software. Once the tool user has received the new production version, additional changes may require repeating the entire process again.

At a next step 112, the tool user may run the new software code with the embedded model in production. In the prior art, the models are not coupled to the recipes. Thus, the tool user may have to have sufficient knowledge about the recipe and the models to determine which model best fit which recipe steps. In addition, the tool user may have to know when a single recipe step may require more than one model in order to fine-tune the recipe to account for the variations, such as different processing chamber conditions.

In an example, the batch of wafers currently being processed in chamber B has previously been processed in chamber A. However, the condition in chamber B is slightly different than condition in chamber A; thus, the recipe may have to be fine-tuned to account for the different processing environment. The tool user is generally responsible for identifying the set of models that may provide the necessary measurement data to perform the fine-tuning. If the tool user lacks the experience and/or skill, the tool user may not be able to quickly identify the correct model and/or may not be aware that two different models may have to be executed in order to obtain the necessary data to perform the fine-tuning of the recipe.

As can be seen from FIG. 1, the task of model building and/or modification is an inflexible time-consuming process that may require the cooperating of an outside party in order to achieve the task. As a result, the prior art method may create the potential for intellectual property exposure. In addition, the prior art method may require the tool user to have a fairly good understanding or the recipe and the models in order to correctly apply the models to generate measurement data that may be utilized for fine-tuning a recipe.

### SUMMARY

The invention relates, in an embodiment, to an arrangement for creating a model for gathering measurement data about a processed substrate by a user of a plasma processing system. The arrangement includes a generic model builder, which is configured for at least creating the model. The model is a relationship between a set of input data and a set of output data. The arrangement also includes an input module, which includes the set of input data from a plurality of input sources. The arrangement includes an input conditioning and validation module, which is configured for at least determining the integrity of the set of input data. The arrangement further includes a relationship module, which is configured for at least creating a set of mathematical relationships. The arrangement yet also includes an output conditioning and validation module, which is configured for at least determining the integrity of the set of output data.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a simple flowchart of a prior art method for obtaining a new model.

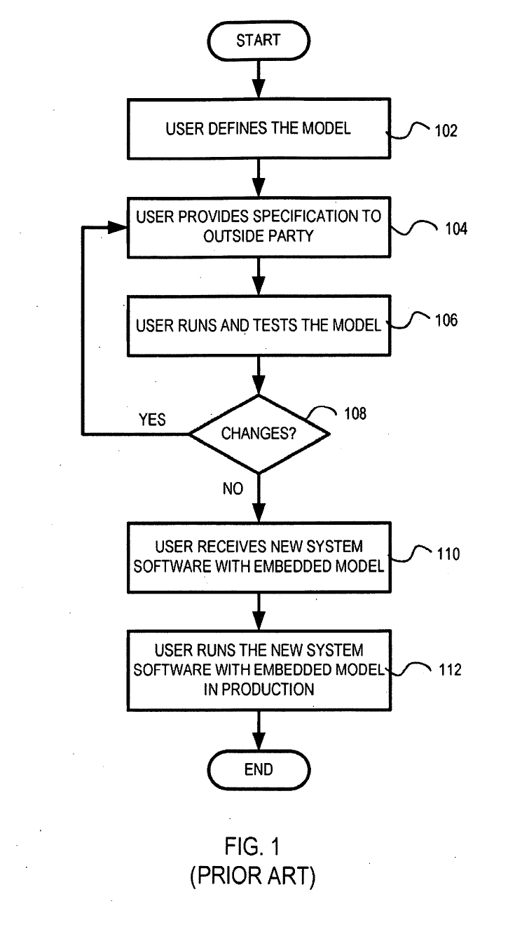

FIG. 2 shows, in an embodiment of the invention, a simple logic diagram of a generic model builder arrangement.

FIG. 3 shows, in an embodiment of the invention, an example of a main view of a user interface for a generic model builder.

FIGS. 4A and 4B show, in an embodiment of the invention, examples of an equation editor.

FIG. 5A shows, in an embodiment of the invention, a simple block diagram illustrating the relationship between a model and a recipe.

FIG. 5B shows, in an embodiment of the invention, an example of a value view of a recipe editor.

FIG. 6 shows, in an embodiment of the invention, a simple flowchart illustrating how a model may be created and/or modified.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

In one aspect of the invention, the inventors herein realized that models may be built locally by a user of a plasma processing system. If a model builder is provided to the user, the user has the ability to create and/or modify a model, as needed, in order to accommodate the changes that a user may experience in production, including different chamber conditions, new recipes, changes to existing recipes, and the like.

In accordance with one or more embodiments of the invention, a generic model building arrangement is provided for creating and modifying models that may be utilized for at least one of performing fault detection, fine-tuning a recipe, and providing an input data to an equation. Embodiments of the invention include modules and methods for validating the integrity of input data, creating mathematical relationships, and verifying the integrity of output data. Embodiments of the invention also include methods for associating a user-created template with a recipe step.

In an embodiment of the invention, a generic model builder arrangement may include a generic model builder, which may be employed to create a new model and/or modify, an existing model. The generic model builder may be configured to accept data from an input module. The input module may include data from a plurality of sources, including, but are not limited to, sensor data, metrology data, end point data, software calculated data, process data, user-defined data, and the like.

In an embodiment the generic model builder may include an input conditioning and validation module. In an embodiment, the input conditioning and validation module may be implemented as separate modules. Since input data may come from a plurality of sources, an integrity check may have to be performed before the input data may be fed into the equation. Accordingly, the input conditioning and validation module may be configured to check the integrity of the input module.

In an embodiment, conditioning may include filtering data. Examples of filtering technique may include, but are not limited to, finite impulse response (FIR) and infinite impulse response (IIR). The filtering techniques may be employed to minimize noise that may occur when external conditions, such as chamber drifting, may cause some of the data (e.g., process data) to be out of out-of-line with other data.

Besides applying filtering techniques, the input conditioning and validation module may also compare data to established ranges. The established ranges may include, but are not limited to, the expected value for the input data, the soft tolerance, the hard tolerance, the minimum value, and the maximum value. In an example, if an input data does not match the expected value, then the input data may have to be at least within the hard tolerance. However, if the input data falls outside of the pre-defined ranges, the input conditioning and validation module may discard the input data as a valid data set that may be fed into the equation.

In an embodiment, the generic model builder may include a relationship module. The relationship module may be configured to enable a user to map input data to input variables. In an embodiment, the relationship module may also be configured to enable a user to create and/or modify mathematical relationship, such as an equation, by combining a set of input variables to a set of mathematical operators. In order to enable a user to tweak the mathematical equation to account for special settings within a recipe, the relationship module ma) also include a matrix transformation tuning component. In an embodiment, the relationship module also allows the user to import in complex mathematical expressions.

In an embodiment, a model may include one or more mathematical relationships. Thus, for a single model, more than one output variables may be generated. In an embodiment, an output conditioning and validation module may be available to check the integrity of the output data. The same filtering techniques as previously discussed may also be applied by the output conditioning and validation module. In addition, the output conditioning and validation module may compare the output data to pre-defined ranges.

Once a model has been created, the user may employ the model to create a series of templates that may be tailored specifically for specific recipe steps, for example. The process of associating a template with a recipe step enable users of different skill and knowledge to execute the recipe with the embedded templates without requiring the users to first set up the relationship between the recipe and the templates.

In an embodiment, an output data from an equation mats be utilized as a recipe set point for fine-tuning a recipe in a production environment. In another embodiment, an output data may be utilized as the input data for another equation. In yet another embodiment, an output data may be employed for performing fault detection. Accordingly, one or more models may be specifically built with equations that may produce output data that may enable a user to perform fault detection.

The features and advantages of the present invention may be better understood with reference to the figures and discussions that follow.

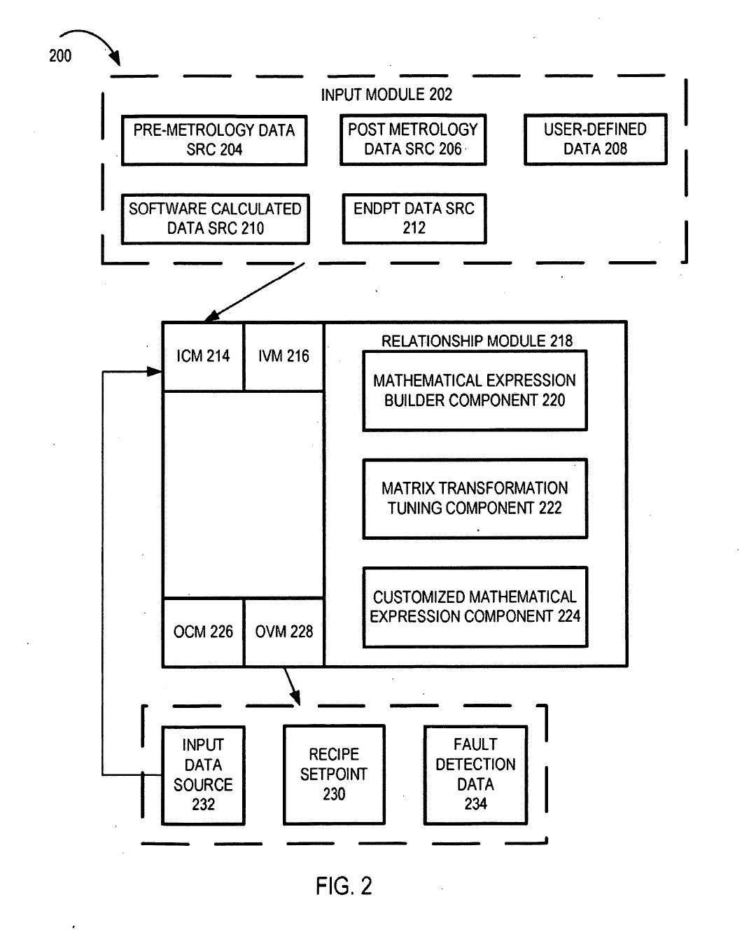

FIG. 2 shows, in an embodiment of the invention, a simple logic diagram of a generic model builder arrangement. A generic model builder arrangement 200 may be employed to represent various ways of representing the relationship between input data and output data. In an embodiment, a generic model builder arrangement 200 may include an input module 202. Input module 202 may include a plurality of input sources (e.g., a pre-metrology data source 204, a post metrology data source 206, a user-defined data 208, a software calculated data source 210, endpoint data source 212, and the like). In an example, pre-metrology data source 204 may include measurement data collected prior to processing a wafer. In another example, software calculated data source 210 may include data calculated by another equation. In yet another example, user-defined data 208 may be employed for intellectual property protection by hiding the proprietary data as an absolute value. As can be appreciated from the foregoing, the possible input sources may vary and may depend upon the user's discretion.

Data from input module 202 may be received by an input conditioning module 214 and an input validation module 216. Before the input data may be utilized in the equation, the integrity of the data may have to be checked, by filtering and/or validation, for example. In an embodiment, input conditioning module 214 is configured to perform filtering on the input data received in order to remove noise. As discussed herein, noise may refer to data that may not be in-line with other data due to external conditions (e.g., drifting within a processing chamber). In order to minimize the noise, filtering techniques, such finite impulse response (FIR) and infinite impulse response (IIR), may be employed.

As discussed herein, FIR refers to a filtering technique in which a set of data for a parameter is normalized. In an example, instead of using the raw data collected from the most recent wafer, the FIR method may include taking the raw data from the most recent five wafers and performing a statistical analysis, such as averaging, to minimize the possibility of noise. Thus, the data that may be fed into the equation may be a better representation of the true characteristic of the parameter

Another filtering technique that may be employed by input conditioning module 214 is IIR. As discussed herein, IIR refers to a filtering technique in which all data collected for a parameter is normalized. In an example, instead of using the raw data collected from the most recent wafer, the IIR method may include performing statistical analysis on all data collected for the parameter. Although the IIR method may include more raw data, the most recent set of data for the parameter may be given a heavier weight than the data that may be historically older. In an example, 100 data sets have been collected. The latest data set may be given a heavier weight (e.g., 80 percent) and the remaining 99 data sets may be given a lighter weight (e.g., 20 percent). Once the data have been weighted, the weighted data may be averaged, for example, to calculate the data set that may be inputted into the equation.

In addition to filtering the data, validation may also occur. In an embodiment, input validation module 216 may be configured to validate the input data by comparing the data to pre-defined ranges. In an example, for each parameter, an expected value, a soft tolerance, a hard tolerance, a minimum value, and a maximum value may be available for comparing the reasonableness of an incoming data. In other words, if the input data fall outside of the established pre-defined ranges, the input data may be discarded. In an example, if the input data minimum value falls below the expected minimum value or exceeds the expected maximum value, the input data may be discarded.

Once data filtering and verification have occurred, the input data may be mapped to one or more input variables. In an example, input data related to critical dimension may be mapped to input variable ffBotCD and/or input variable ffMidCD, for example. By mapping the input sources to the input variables, the data may be automatically pulled from the sources instead of relying on manual intervention.

In an embodiment, generic module builder arrangement 200 may include a relationship module 218. In an embodiment, relationship module 218 may include a mathematical expression builder component 220, a matrix transformation tuning component 222, and a customized mathematical expression component 224. In an embodiment, each component of relationship module 218 may be individually employed to create the mathematical relationships. In another embodiment, one or more components of relationship module 218 may work together in creating one or more mathematical relationships.

Traditionally, a mathematical relationship, such as an equation, may be created by combining one or more input variables with one or more mathematical operators. In an embodiment, a user may activate mathematical expression builder component 220 to enter and/or to select a set of input variables for a mathematical relationship. In addition, the user may combine the set of input variables with a set of mathematical operators to create the mathematical relationship. In an example, the user may select ffMidCD and ffBotCD as the input variables and the multiplication symbol (*) and the square root symbol (sqrt) as the mathematical operators to create the mathematical relationship [ffMidCD*(sqrt)(ffBotCD)].

Additionally or alternatively, matrix transformation tuning component 222 may be employed to create a mathematical relationship. Certain mathematical relationships may be more abstract and may require manipulation. To enable this type of mathematical relationships to be expressed, matrix transformation tuning component 222 may be employed to define this type of mathematical relationship.

Both mathematical expression builder component 220 and matrix transformation tuning component 222 allow the user to create his own mathematical relationship. However, a plurality of mathematical relationships, especially complicated ones, may have already been defined and are available through a plurality of math software programs (such as MATHLAB®). To take advantage of the readily available mathematical relationships, generic model builder arrangement 200 may include customized mathematical expression component 224. By implementing customized mathematical expression component 224, the user may integrate complex mathematical relationships available through a third party into the model that is being built and/or modified.

In an embodiment, generic model builder arrangement 200 may include an output conditioning module 226 and an output validation module 228. Output conditioning module 226 and output validation module 228 may behave similar to input condition module 214 and input validation module 216. However, instead of analyzing the input data, output conditioning module 226 and output validation module 228 are analyzing the output data. In other words, the output data are being cleaned (e.g., eliminate noise, discard output data that fall outside of pre-defined ranges, and the like).

In the prior art the output data is generally utilized to fine-tune a recipe. Unlike the prior art, the output data may have many different purposes. In an example, the output data may be utilized as a recipe setpoint 230 for one or more recipe steps. Besides being utilized as recipe setpoint 230, the output data may also be utilized as an input data source 232 for another equation. In addition, the output data may be employed for performing fault detection 234. In an example, output data may indicate that the processing chamber may have experienced a significant amount of drifting and that the wafers processed in the processing chamber may be defective if the processing chamber is not cleaned.

As can be appreciated from FIG. 2, by implementing generic model builder arrangement 200, a user may be capable of creating his own models without having to rely on a third party. Since the user is no longer dependent upon an outside party to create and/or build a model, the turnaround time may be significantly decreased. In addition, the risk of intellectual property exposure may be significantly eliminated since proprietary data is no longer being shared with an outsider.

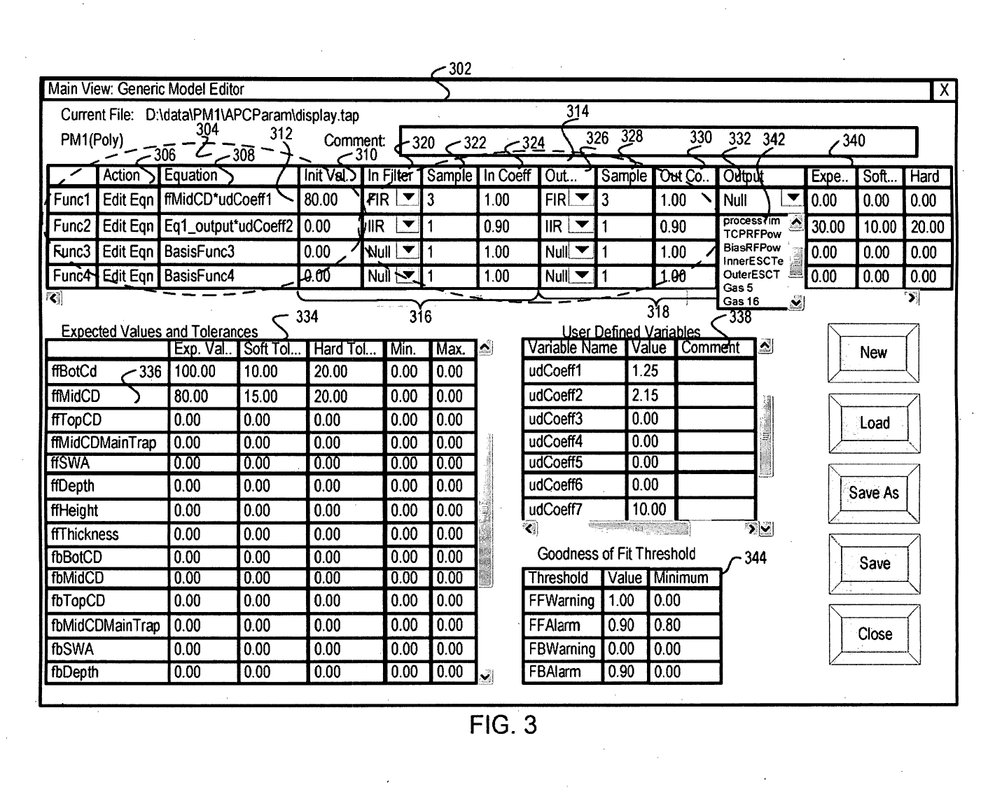

FIG. 3 shows, in an embodiment of the invention, an example of a main view of a user interface for a generic model builder. As aforementioned, a generic model builder may be employed to create a new model and/or modify a current model. Main view of user interface 302 may include an equation module 304, which may enable one or more mathematical relationships, such as equations, to be created and/or modified. Equation module 304 may include an action section 306, an equation section 308, and an initial value section 310.

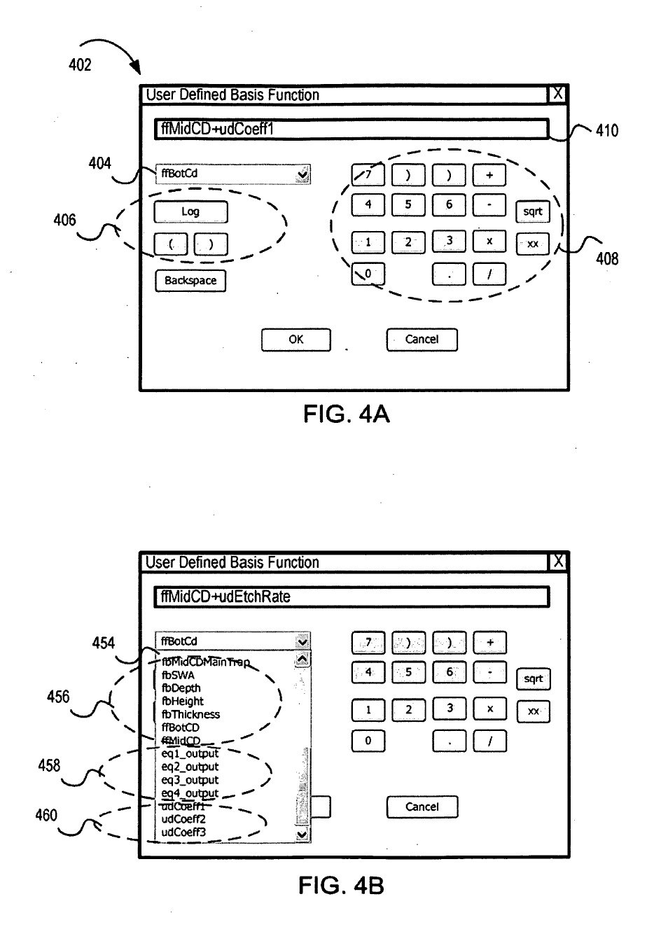

Action section 306 allows a user to perform an action to an equation. In an example, by clicking on an action cell of action section 306, an equation editor 402 may appear, as shown in FIG. 4A. Equation editor 402 may be employed to create and/or modified an equation. In an embodiment, equation editor 402 may include one or more components of the relationship module of FIG. 2. Thus, the user is able to create equation using at least one of the relationship module components. Thus, the type of equations a user may be able to create may include simple equations, straight-forward equations, equations that may require user's manipulation, complex equation from outside vendors, and the like.

In an embodiment, equation editor 402 may include an input variable list 404, which may be a user-selectable list enabling a user to select from a plurality of input variables, such as those shown in input variable list 454 of FIG. 4B. Input variable list 454 may originate from a variety of sources, including but not limited to, sensor and metrology data (segment 456), outputs from other equations (segment 458), and user-defined variables (segment 460).

By combining one or more input variables with mathematical operators, such as those shown in segments 406 and 408, a user may be able to create an equation. In an example, the user is able to create equation 410 by combining input variable “ffMidCD” and input variable “udCoeff1” with an addition operator (+). As can be appreciated from the foregoing, the number of input variables and mathematical operators that may be included in an equation may vary depending upon a user's discretion.

Once the equation has been created, the equation may show up in equation section 308. In an example, equation 410 (e.g., ffMidCD+udCoeff1) may show up in an equation cell 312 of equation section 308. Unlike the prior art, the number of equations that may be created and/or modified may vary. In this example, four equations may be created and/or modified. By enabling more than one equation to be associated with one model, a single model may be employed to address the different parameters of a recipe step that may have to be adjusted when a recipe has to be fine-tuned.

In an embodiment, each equation may have an initial value if a value is not provided or is not yet available, as shown in initial value section 310. In an example, a model may have two equations, with the second equation being dependent upon the first equation to provide one of the input values needed. During the first execution of the model, the initial value of the first equation may be a defaulted value, such as 80.00, for example, in order to enable the second equation to computer the output value.

In an embodiment, main view of user interface 302 may also include a conditioning module 314, which may be employed to filter out data. Examples of data filtering may include, but are not limited to, finite impulse response (FIR) and infinite impulse response (IIR). As aforementioned, filtering may be applied to the input and/or output data in order to test the integrity of the data. In other words, filtering may be performed in order to eliminate noise that may occur due to external conditions. In an example, filtering may enable raw data that may have been collected under less than favorable conditions, to be averaged, for example, in order to substantially eliminate the noise factor.

Conditioning module 314 may include an input filtering section 316 and an output filtering section 318. Each section may include a filtering technique section, a number of samples section, and a coefficient section. In an example, input filtering technique section 320 may allow the user to define the type of filtering technique, such as FIR and IIR, that may be applied. If the FIR filtering technique is chosen, the user may be able to define a given number of samples that may be utilized. In an example, under an input number of sample section 322, three samples may be employed during the FIR filtering technique for the first equation. However, if the IIR filtering technique is chosen, then the user may be able to indicate under an input coefficient section 324 the weight value of the most recent data set. In an example, the user may enter 0.90 as the input coefficient. As aforementioned, output filtering section 318 may also include similar sections (an output filtering technique section 326, an output number of samples section 328, and an output coefficient section 330) as those described in input filtering section 316.

In an embodiment, the generic model builder may also include an output section 332, which may enable a user to determine how the output may be utilized. In an example, a user may associate an output to a particular recipe setpoint by providing the parameter name. In another example, the user may chose “null” to indicate the output value may be employed as an input for another equation or may be utilized to perform fault detection.

Main view of user interface 302 may also include an input validation module 334, in an embodiment. Input validation module 334 may be employed to validate the data for the input variables. In an embodiment, for each input variables, an expected value, a soft tolerance, a hard tolerance, a minimum, and a maximum may be provided. In an example an input variable 336 (e.g., ffMidCD) may have an expected value of 80.00 with a soft tolerance of 15.00 and a hard tolerance of 20.00. Thus, if the input data for ffMidCD falls outside of the defined range, the input data may be discarded, for example.

In an embodiment, main view of user interface 302 may also include a user-defined variable module 338. As aforementioned, the generic model builder enables the user to add input variables. The user may add additional input variables by defining the variables in user-defined variable module 338. In an example, the use may define an udCoeff1 as 1.25 and an udCoeff2 as 2.15. By employing a user-defined variable, the user is able to hide proprietary data, such as a special setting of a recipe that may give the company a competitive edge. By employing a user-defined variable, the user may be able to manipulate an equation without exposing the proprietary data in order to account for uniqueness of the recipe.

In addition, main view of user interface 302 may also include an output validation module 340, which may be employed to validate the output data. For each output variable, a range may be defined. In an embodiment, the range ma, include an expected value, a soft tolerance, and a hard tolerance. In an example, the expected value for process time (as shown in output cell 342) is 30.00 with a soft tolerance of 10.00 and a hard tolerance of 20.00. During production run, the actual output may be gauged against the values as defined in output validation module 340. If the value is within the range set, the output may be employed to adjust a recipe setpoint and/or to be an input variable for another equation. However, the output value may also be utilized to perform fault detection, especially, if the output value falls outside of the tolerance levels.

In an embodiment, main view of user interface 302 may also include a goodness of fit (GOF) threshold module 344, which may be employed to check the confidence level of input data. Those skilled in the art are aware that a GOF is usually employed to determine the discrepancy between the actual value and the expected value. Usually, the minimal value is checked against the GOF minimum value. In this example, GOF threshold module 344 enables warnings to be activated if an input variable is not within a confidence level as defined. In an example, an FFWarning is activated if the value is greater than 1.00.

As can be appreciated from the foregoing, FIGS. 3 and 4 show examples of user interface that may assist a user in creating a new model and/or modifying an existing model. With a generic model builder, models may be created and/or modified without requiring the assistance of an outside party. Therefore, the risk of exposing intellectual property to an outside party is significantly eliminated since a model may be created and/or modified without requiring the proprietary recipe to be shared with an outside party. In addition, the creation and/or modification of the model may now have a faster turn around time since the model may now be handled internally instead of competing with other requesters for the engineer's time.

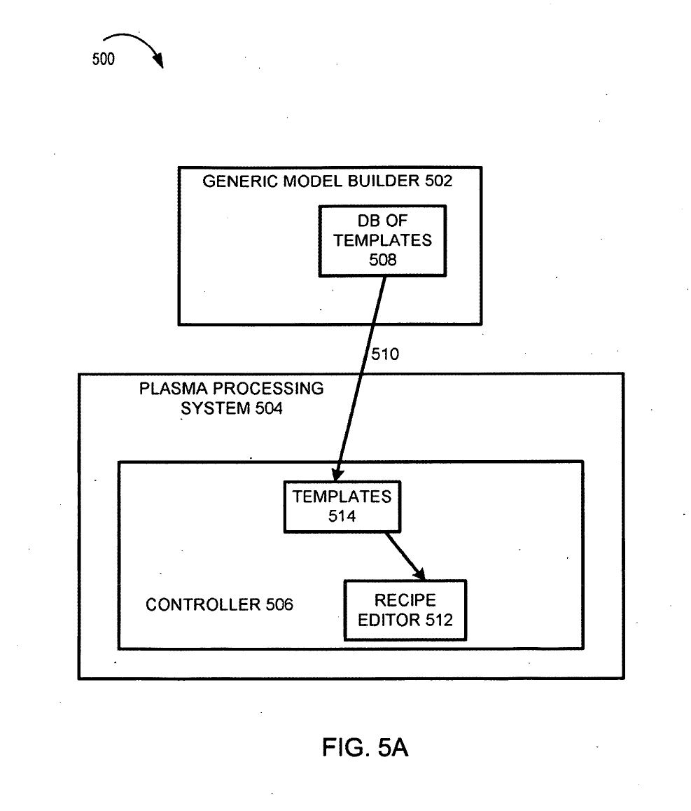

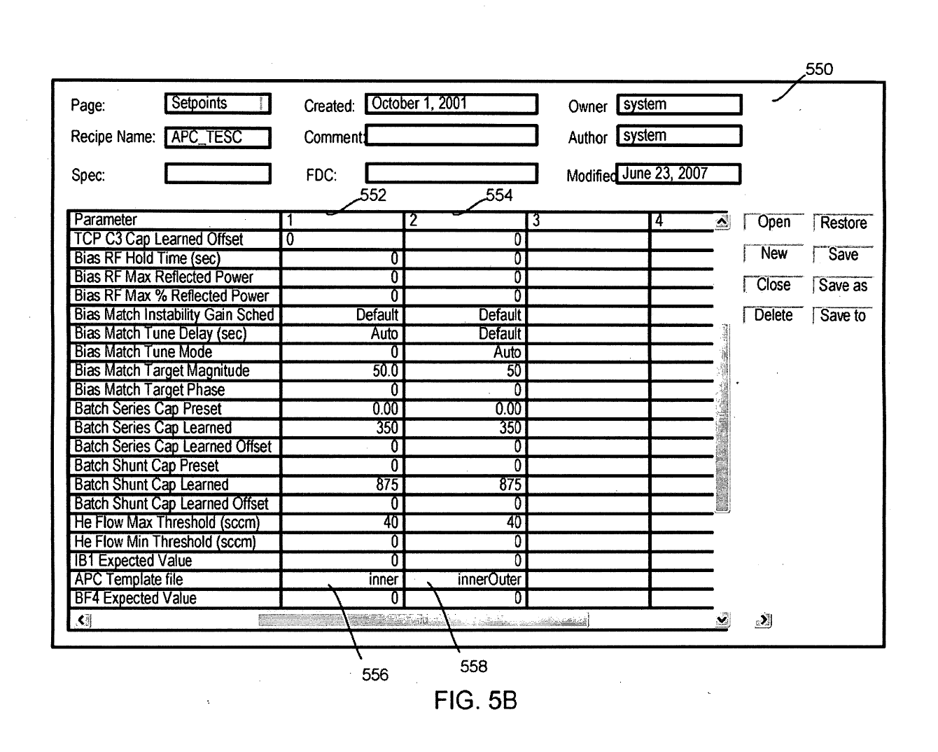

FIG. 5A shows, in an embodiment of the invention, a simple block diagram illustrating the relationship between a model and a recipe. Arrangement 500 may include a generic model builder 502 and a plasma processing system 504. Generic model builder 502 may be a software program that may be agnostic of location. In an embodiment, generic model builder 502 is configured to interact with a controller 506 of plasma processing system 504, either directly or through an intermediary component, in order to enable data exchange to occur between generic model builder 502 and plasma processing system 504.

As aforementioned, generic model builder 502 may be employed to create new models and/or modified current models. Once each model has been created and/or modified, one or more templates may be created from each model. As discussed herein, a template refers to a model that has been tailored for specific step of a recipe within a specific processing chamber. In an embodiment, generic model builder 502 may include a database 508 for storing the plurality of templates.

Database 508 of templates may be transmitted from generic model builder 502 to controller 506 of plasma processing system 504 via a path 510. Thus, controller 506 may store current version of available templates 514 associated with plasma processing system 504.

In an embodiment a recipe editor 512, which may reside within controller 506 may be configured to associate a template with a recipe step. FIG. 5B shows, in an embodiment of the invention, an example of a value view of a recipe editor 550. In the value view, beside entering values for each of the parameters (e.g., bias match, max flow, helium flow, etc.) for a recipe, the user may also employ recipe editor 550 to associate a template with a recipe step.

In an example, recipe editor 550 may include a recipe with two steps (as shown by column 552 and column 554). For each step, a template may be selected at cells 556 and 558 for steps 1 and 2, respectively. In this example, a template known as “inner” has been associated with step 1 while a template known as “innerOuter” has been associated with step 2.

By associating a template with a recipe step, the task of associating a template with a recipe step is determined once. Unlike the prior art, the user is not required to have an in-depth knowledge of either the recipe and/or the templates in order to utilize the templates in gathering measurement data. As can be appreciated from the foregoing, by coupling a template to a recipe step, the decision associated with determining which templates belong with which recipe steps have been essentially eliminated on an ongoing basis.

In addition, the task of creating and/or modifying a model is not dependent upon a schedule of the tool manufacturer. Instead, the customer may employ the generic model builder to create and/or modify a model. Thus, the turnaround time for the creation and/or modification of the model may be significantly reduced.

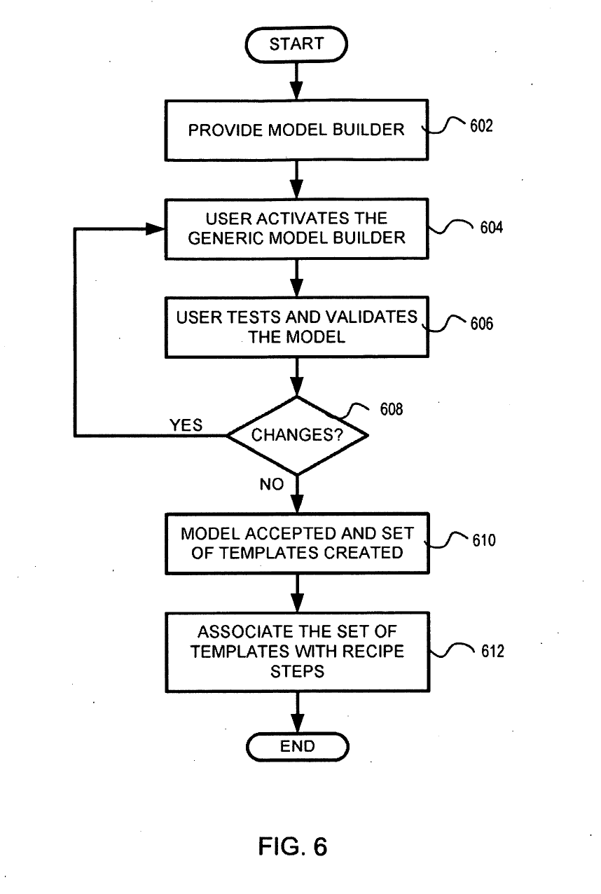

FIG. 6 shows, in an embodiment of the invention, a simple flowchart illustrating how a model may be created and/or modified.

At a first step 602, a manufacturer of plasma processing system may provide a user with a generic model builder. Unlike the prior art, the generic model builder may be an integral part of the plasma processing system.

At a next step 604, the user may activate the generic model builder to create or modify a model. Unlike the prior art, each model may be created by the user without having to bring in an outside party to perform the task. Thus, the user may protect his company's intellectual property from being exposed to an outside party. In addition, the task of creating and/or modifying a model is not dependent upon a tool manufacturer's schedule. Instead, the customer may employ the generic model builder to create and/or modify a model. Thus, the turnaround time for the creation and/or modification of the model may be significantly reduced.

At a next step 606, the user may test and validate the model. In an example, the user may run a simulation to obtain measurement data that may determine whether or not a uniformity problem, for example, has been fixed.

At a next step 608, the method allows for determining if the model needs to be modified. If additional changes are needed, steps 604 to 606 may be repeated. Although changes may be identified during the testing phase, the changes may be quickly implemented without having to work around an outside party's schedule. Thus, a model may be built and/or modified in a timely manner.

However, if no changes are required, then at a next step 610, the model is accepted and a set of templates may be created.

At a next step 612, the user may associate the set of templates with recipe steps. Unlike the prior art, the templates may be coupled to the recipe, thereby eliminating the need for a user to have to make a determination on which template may have to be executed during a production run.

As can be appreciated from the forgoing, one or more embodiments of the present invention provide for a generic model builder arrangement for creating and/or modifying models in order to enable recipe fine-tuning. By utilizing a generic model builder arrangement, a user is able to protect intellectual property while maintaining control over the models. In addition, by coupling a template to a specific recipe step, the generic model builder arrangement enables less knowledgeable users to be able to fine-tune a recipe without having an in-depth knowledge of the recipe and/or templates. Further, the generic model builder arrangement is an inexpensive solution that is backward compatible, thereby enabling owner of current plasma processing system to implement the generic model builder arrangement without incurring additional high ownership cost.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, ones or more than one member. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. An arrangement for creating a model for gathering measurement data about a processed substrate by a user of a plasma processing system, comprising:
a generic model builder, said generic model builder being configured for at least creating said model, said model being a relationship between a set of input data and a set of output data;
an input module, said input module including said set of input data from a plurality of input sources;
an input conditioning and validation module, said input conditioning and validation module being configured for at least determining the integrity of said set of input data;
a relationship module, said relationship module being configured for at least creating a set of mathematical relationships; and
an output conditioning and validation module, said output conditioning and validation module being configured for at least determining the integrity of said set of output data.

2. The arrangement of claim 1 wherein said plurality of input sources include user-defined sources, pre-metrology data source, post-metrology data source, sensor data source, endpoint data source, and software-calculated data sources.

3. The arrangement of claim 2 wherein said relationship module is configured for mapping a set of input variables to said set of input data.

4. The arrangement of claim 3 wherein said relationship module is configured to include at least one of a mathematical expression component, a matrix transformation tuning component, and a customized mathematical expression component.

5. The arrangement of claim 4 wherein said set of output data is associated with at least one of a recipe setpoint, an input data for another mathematical relationship, and a data for performing fault detection.

6. The arrangement of claim 5 wherein a set of templates is created from said model by entering values for parameters for at least one of said input conditioning and validation modules and said output conditioning and validation modules.

7. The arrangement of claim 6 wherein a template of said set of templates is associated with a first recipe step.

8. A method for creating a model for gathering measurement data about a processed substrate by a user of a plasma processing system, comprising:
activating a generic model builder, said generic model builder being configured for at least creating said model, said model being a relationship between a set of input data and a set of output data;
establishing at least one of filtering conditions and validation rules for an input conditioning and validation module, said input conditioning and validation module being configured for at least determining the integrity of said set of input data;
creating a set of mathematical relationships, wherein a first mathematical relationship of said set of mathematical relationships includes at least a first input variable of a set of input variables and a set of mathematical operator, said first mathematical relationship being configured for at least providing a first output data of said set of output data; and
establishing as least one of filtering conditions and validation rules for an output conditioning and validation module, said output conditioning and validation module being configured for at least determining the integrity of said set of output data.

9. The method of claim 8 further includes mapping said set of input variables to said set of input data received from a plurality of input sources.

10. The method of claim 9 wherein said plurality of input sources include user-defined sources, pre-metrology data source, post-metrology data source, sensor data source, endpoint data source, and software-calculated data sources

11. The method of claim 10 wherein said first mathematical relationships is created by a relationship module, said relationship module being configured to include at least one of a mathematical expression component, a matrix transformation tuning component, and a customized mathematical expression component.

12. The method of claim 11 further includes creating a second mathematical relationship of said set of mathematical relationships, said second mathematical relationship including at least a second input variable of said set of input variables and said set of mathematical operator, said second mathematical relationship being configured for at least providing a second output data of said set of output data.

13. The method of claim 12 further includes defining said set of output data as being at least one of a recipe setpoint, an input data for another mathematical relationship, and a data for performing fault detection.

14. The method of claim 13 further includes creating a set of templates from said model by entering values for at least one of said filtering conditions and said validation rules.

15. The method of claim 14 further includes associating a first template of said set of template with a first recipe step.

16. An article of manufacture comprising a program storage medium having computer readable code embodied therein, said computer readable code being configured for creating a model for gathering measurement data about a processed substrate by a user of a plasma processing system, comprising:
code for activating a generic model builder, said generic model builder being configured for at least creating said model, said model being a relationship between a set of input data and a set of output data;
code for establishing at least one of filtering conditions and validation rules for an input conditioning and validation module, said input conditioning and validation module being configured for at least determining the integrity of said set of input data;
code for creating a set of mathematical relationships, wherein said set of mathematical relationships includes at least a set of input variable and a set of mathematical operator, said set of mathematical relationship being configured for at least providing said set of output data; and
code for establishing as least one of filtering conditions and validation rules for an output conditioning and validation module, said output conditioning and validation module being configured for at least determining the integrity of said set of output data.

17. The article of manufacturing of claim 16 further includes a code for mapping said set of input variables to said set of input data received from a plurality of input sources.

18. The article of manufacturing of claim 17 further includes a code for defining said set of output data as being at least one of a recipe setpoint, an input data for another mathematical relationship, and a data for performing fault detection.

19. The article of manufacturing of claim 18 further includes a code for creating a set of templates from said model by entering values for at least one of said filtering conditions and said validation rules.

20. The article of manufacturing of claim 19 further includes a code for associating a first template of said set of template with a first recipe step.
